(19) United States
(12) Patent Application Publication
(10) Pub. No.: US 2014/0195858 A1
(43) Pub. Date: Jul. 10, 2014

(54) METHODS, SYSTEMS, AND NON-TRANSITORY MACHINE-READABLE MEDIUM FOR PERFORMING A WEB BROWSER TO WEB BROWSER TESTING OF A COMPUTER SOFTWARE APPLICATION

(71) Applicant: Appvance Inc., San Jose, CA (US)

(72) Inventor: Frank Cohen, Campbell, CA (US)

(73) Assignee: Appvance Inc., San Jose, CA (US)

(21) Appl. No.: 14/149,685

(22) Filed: Jan. 7, 2014

Related U.S. Application Data
(60) Provisional application No. 61/749,877, filed on Jan. 7, 2013.

(51) Int. Cl. G06F 11/36

(52) U.S. Cl. CPC G06F 11/3624
USPC 714/38.14

(57) ABSTRACT

Methods, devices, systems, and non-transitory machine-readable medium for performing a World Wide Web (“Web”) browser to Web browser testing of a computer software application may include receipt of an instruction to open a recording computer software application in a recording Web browser and the subsequent opening of the recording computer software application. A subsequent instruction to open a target computer software application in a target Web browser session presented by a second Web browser may then be received. The recording application may then record one or more events resulting from the user's interaction with the target computer software application running within the target Web browser session.

### RELATED APPLICATIONS

This application is a NON-PROVISIONAL of and claims priority to U.S. Application No. 61/749,877 filed Jan. 7, 2013, which claims priority to U.S. Provisional Patent Application No. 61/749,664 entitled Methods, Systems, and Non-Transitory Machine-Readable Medium For Performing An Automated Testing Of A Computer Software Application filed on Jan. 7, 2013; and U.S. Provisional Patent Application No. 61/749,816 entitled Methods, Systems, and Non-Transitory Machine-Readable Medium For Performing an Automated Calibration for Testing Of A Computer Software Application filed on Jan. 7, 2013, all of which are incorporated herein by reference.

### FIELD OF INVENTION

The present invention relates to a method, device, system, and non-transitory machine-readable medium for performing a World Wide Web (“Web”) browser to Web browser testing of a computer software application.

### BACKGROUND

Until this invention software testing required dedicated desktop test application software to generate and insert programmatic hooks into a browser to accomplish test script creation and test script playback of a computer software application.

### SUMMARY

Methods, devices, systems, and non-transitory machine-readable medium for performing a World Wide Web (“Web”) browser to Web browser testing of a computer software application are herein described.

An instruction to open a recording computer software application in a recording Web browser session presented by a first Web browser may be received by, for example, a computer system communicatively coupled to the World Wide Web (Web). The instruction may be received from a user or software tester. The recording computer software application may be configured to record the user's interaction with a target computer software application operating during a target Web browser session. The recording computer software application may then be opened in the recording Web browser session responsively to the received first instruction.

A subsequent instruction to open a target computer software application in a target Web browser session presented by a second Web browser may then be received. The target computer software application may then be opened by the recording application running on the computer system within the target Web browser session responsively to the received second instruction. The recording application may then record one or more events resulting from the user's interaction with the target computer software application running within the target Web browser session. On some occasions, the one or more events are triggered by operation of a test script by the user as part of a performance test of the target computer software application. In some embodiments, the recorded events may be communicated to the user via the recording Web browser session.

Optionally, the recorded events may then be stored in, for example, a database or other data storage device. The recorded events may be stored as a formatted file and/or source code. In some instances, the recorded events may be analyzed and the results of this system the user. On some occasions, the analysis may be performed by, for example, a processor running a software analysis computer software application and/or analytics hardware.

In some embodiments, the target software application may be debugged via, for example, the web browser using the present invention. As part of the debugging process permission to debug the target software application may be received from the target software application. In some instances, the permission may be received upon execution of a test script by the user via the target software application or upon recordation of a particular type of event (e.g., error or time out). Upon receiving the permission, debugging instructions may be received from the user and implemented within the target computer software application.

In some embodiments, recorded events may be used to automatically execute actions within the target computer software program, for example, as a test script or other mechanism to test the target computer software application.

In another embodiment the recorded events may be reformatted to be compatible with a Web browser other than the Web browser presenting the target computer software application and the reformatted recorded events may be provided to the user via the first Web browser. On some occasions, the reformatted recorded events may be used to trigger events similar to the user's interaction with the target computer software application while a Web browser other than the second Web browser presents the target computer software application and one or more events triggered by using the reformatted recorded events may be recorded will by the recording application running on the computer system, one or more events triggered by using the reformatted recorded events.

In some embodiments, the recorded events may be processed to recognize objects like JavaScript objects. The objects may then be reformatted to be compatible with a Web browser other than the second Web browser and provided to the user via the first Web browser. On some occasions, the reformatted recorded objects may be used to trigger events similar to the user's interaction with the target computer software application while a Web browser other than the second Web browser presents the target computer software application and events triggered by using the reformatted recorded objects may be recorded.

In some cases, the recorded events may be normalized for use with an application programming interface (API) native to a Web browser other than the second Web browser. In some embodiments, the normalization may be user configurable. The normalized recorded events may then used to perform a test of the target computer software application while the Web browser other than the second Web browser presents the target computer software application and performance of the test may be recorded.

### BRIEF DESCRIPTION OF THE DRAWINGS

The present application is illustrated by way of example, and not limitation, in the figures of the accompanying drawings, in which:

FIG. 1 is a block diagram illustrating an exemplary system for performing an automated testing of a computer software application;

FIG. 2 is a block diagram illustrating exemplary components included within a computer system, in accordance with some embodiments of the present invention;

FIGS. 3-5 are flow charts depicting exemplary processes, in accordance with some embodiments of the present invention; and

FIG. 6 is a screen shot depicting exemplary Web browser to Web browser testing of a software application, in accordance with some embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### WRITTEN DESCRIPTION

The Web browser to Web browser software testing of the present invention relates to a recording test computer software application that runs in one browser to record the workflow and user experience of a computer software application running in a second browser.

The browser-to-browser software testing of the present invention removes the requirement to build complicated hooks into a computer software application to be tested and further removes the requirement to maintain/update those hooks. The browser-to-browser software testing of the present invention delivers a browser-based computer software application containing a test recording/playback mechanism and controls to command the computer software application under test to perform tasks within its browser.

Exemplary advantages of the present invention include:
1) The recorder computer software application requires no pre-installation. A browser downloads the recorder computer software application at test authoring time.
2) The recorder computer software application provides controls to start, stop, and pause recording a user's interaction in the target computer software application under test.
3) The recorder computer software application creates a test recording containing the steps taken, including, for example, mouse clicks, keyboard typing, and gestures.
4) The recorder computer software application plays a recording of the target computer software application under test in a second browser. The recorder computer software application provides controls to pause playback.

Additionally, the Web browser to Web browser software testing of the present invention enables testing of target computer software applications that are complaint with the W3C3 Standard for Web browsers. The W3C3 Standard requires Web browsers to implement a Same Origin Policy to ensure that site content is not accessible by a script from another site. As such, code for a particular Website loaded within the Web browser can only operate within that Website's domain. For example, JavaScript code loaded from www.mysite.com does not run against www.mysite2.com. Same Origin Policy prevents Cross-site Scripting (XSS.) Without Same Origin Policy a script placed on any Website would be able to read information from a second site opened in another browser window.

The herein described Web browser to Web browser test recording supports Same Origin Policy by using scripts to be placed in the same origin as the Application Under Test, using the same URL. Thus, the herein described Web browser to Web browser test recording uses the browser's native APIs and spoofing techniques to work within Same Origin Policy protocols without stopping the recording process.

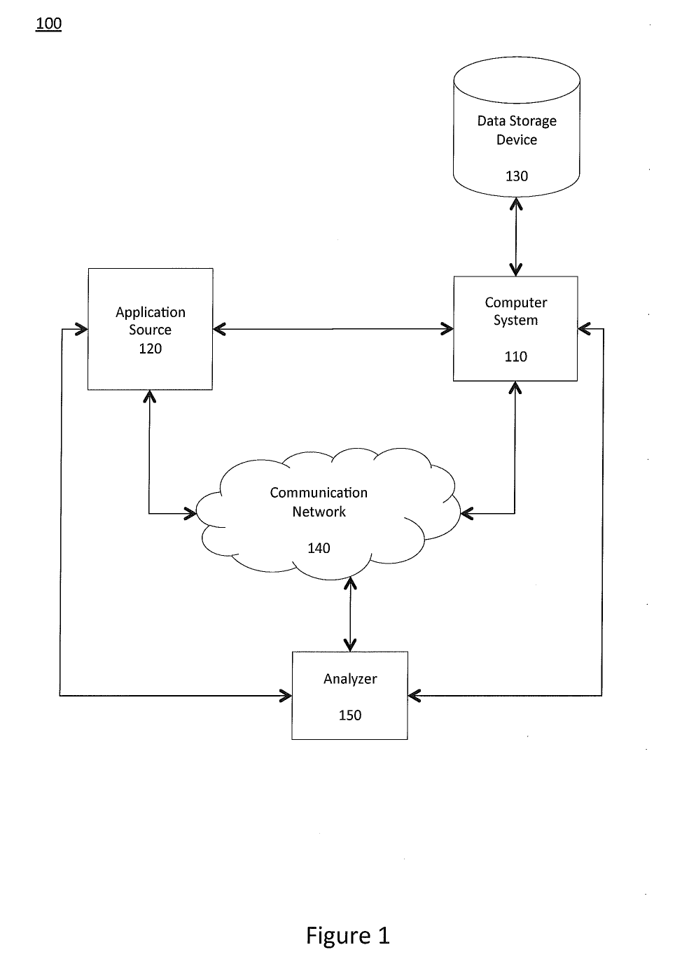

Referring now to FIG. 1, an example of a system 100 including elements thereof configured to perform a Web browser to Web browser testing of a computer software application. The components of system 100 may be communicatively coupled to one another via, for example, a direct connection and/or a connection via a communication network 140. Communication network 140 may be any network enabling communication between any of the components included within system 100, such as the Internet, a local area network (LAN), a wireless local area network (WLAN), and/or any other appropriate network.

In one exemplary embodiment, a computer system 110 may receive a software application for testing from an application source 120. The software application may include a plurality of discrete sets of instructions, sometimes referred to as methods or functions, for executing one or more functionalities. Application source 120 may be any source, or combination of sources, of a software application. Exemplary application sources 120 include computers, software application users, and/or software application developers. A target computer software application may be transmitted from application source 120 to computer system 110 via communication network 140.

Computer system 110 may be configured to receive a first instruction from a user to open a recording computer software application in a recording Web browser session presented by a first Web browser via a display device (not shown) coupled to and/or included in computer system 110. The recording computer software application being configured to record the user's interaction with a target computer software application operating during a target Web browser session. Computer system 110 may then open the recording computer software application in the recording Web browser session responsively to the received first instruction

Computer system 110 may be further configured to receive a second instruction from the user to open a target computer software application in a target Web browser session presented by a second Web browser. The recording application running on computer system 110 may then proceed to open the target computer software application within the target Web browser session responsively to the received second instruction and proceed to record one or more events resulting from the user's interaction with the target computer software application running within the target Web browser session.

Analyzer 150 may be any device configured to analyze recorded events, such as a computer system configured with analysis software and in some instances may be a stand-alone analytics hardware device. In some embodiments, analyzer 150 may be resident within computer system 110.

A data storage device 130 may be communicatively coupled to computer system 110. Data storage device 130 may be any data storage device, combination of data storage devices, and/or database enabled to store recorded events and/or a set of instructions for execution by computer system 110 and/or system 100.

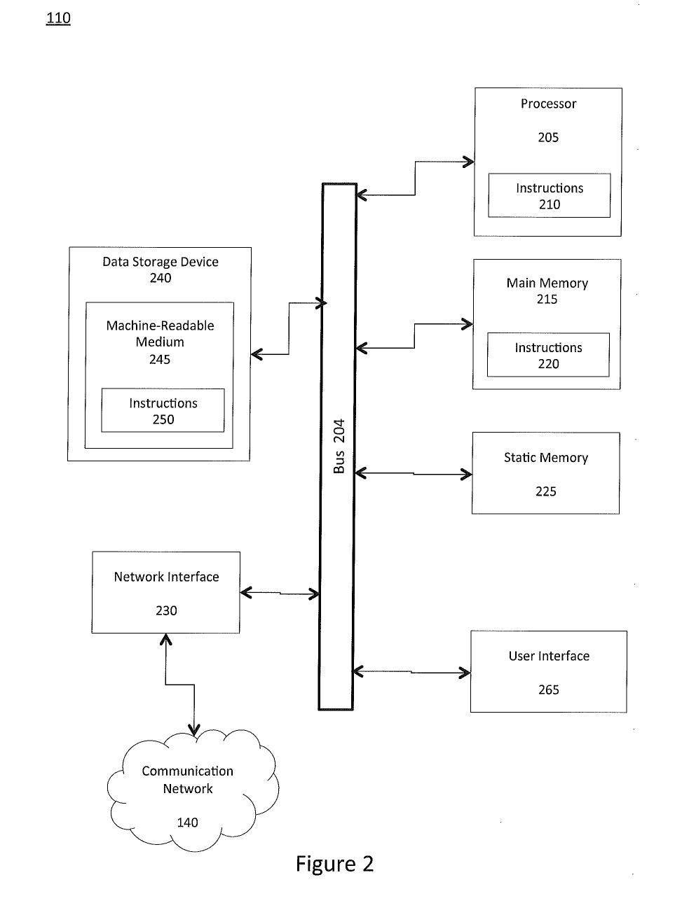

FIG. 2 is a block diagram illustrating one example of a computer system 110 within which a set of instructions 210, 220, and 250 for causing computer system 110 to perform any one or more of the methodologies discussed herein may be executed. In this example, components of computer system 110 are coupled directly, or indirectly, to a communication bus 204, although in other cases layers of busses or, indeed, different busses or other communication paths may be used to communicatively couple the various components of this device. Therefore, it should be appreciated that the example shown in FIG. 2 is intended only as one possible computer system configuration and is not intended to limit the scope of the present invention in any way.

In alternative embodiments, computer system 110 operates as a standalone device or may be connected (e.g., communication network 140) to other machines. In a network deployment, computer system 110 may operate in the capacity of a client machine in a server-client network environment, or as a peer machine in a peer-to-peer (or distributed) network environment.

Computer system 110 includes a network interface device 230 coupled to bus 204. Network interface device 230 provides a two-way data communication path with computer system 110. For example, network interface device 230 may be a wired or wireless local area network (LAN) interface to provide a data communication connection to a compatible LAN (such as a LAN that uses an IEEE 802.11a/b/g/n communication protocol). Computer system 110 can send messages and receive data, sets of instructions, and/or content elements through network interface device 230. A user of computer system 110 may communicate with computer system 110 via user interface 265. Exemplary user interfaces 265 include a keyboard, mouse, and microphone.

Computer system 110 also includes a processor 205 (e.g., a central processing unit (CPU), a graphics processing unit (GPU), or both), a main memory 215 (e.g., read-only memory (ROM), flash memory, dynamic random access memory (DRAM) such as synchronous DRAM (SDRAM) or Rambus DRAM (RDRAM), etc.), and a static memory 225 (e.g., flash memory, static random access memory (SRAM), etc.), which communicate with each other via a bus 204 or other communication mechanism for communicating information.

Computer system 110 may further include a data storage device 240 and a main memory (e.g., RAM) 215 for storing, for example, a received software application including one or more sets of instructions 220. Data storage device 240 may include a non-transitory machine-readable storage medium 245 on which is stored one or more sets of instructions 250 (e.g., software) embodying any one or more of the methodologies or functions described herein. Set of instructions 250 as well as any received software application may also reside, completely or partially, within main memory 215 and/or within processor 205 during execution of various operations by computer system 110. In some embodiments, static memory 225 and processor 205 may also constitute non-transitory machine-readable storage media (at least in part). In some cases, set of instructions 250 may be transmitted or received over a communication network 140 via network interface device 230 as, for example, a software application or an update to a software application. In alternative embodiments, hard-wired circuitry may be used in place of, or in combination with, set of instructions 250 to implement the invention. Thus, embodiments of the invention are not limited to any specific combination of hardware circuitry and software.

While set of instructions 250 are shown in an exemplary embodiment to be on a single medium 245, the term “non-transitory machine-readable storage medium” should be taken to include a single medium or multiple media (e.g., a centralized or distributed database or data source and/or associated caches and servers) that store the one or more sets of instructions 250. The term “non-transitory machine-readable storage medium” shall also be taken to include any non-transitory medium that is capable of storing, encoding, or carrying a set of instructions for execution by computer system 110 and that cause computer system 110 to perform any one or more of the methodologies of the present invention. The term “non-transitory machine-readable storage medium” shall accordingly be taken to include, but not be limited to, solid-state memories, optical media, and magnetic media.

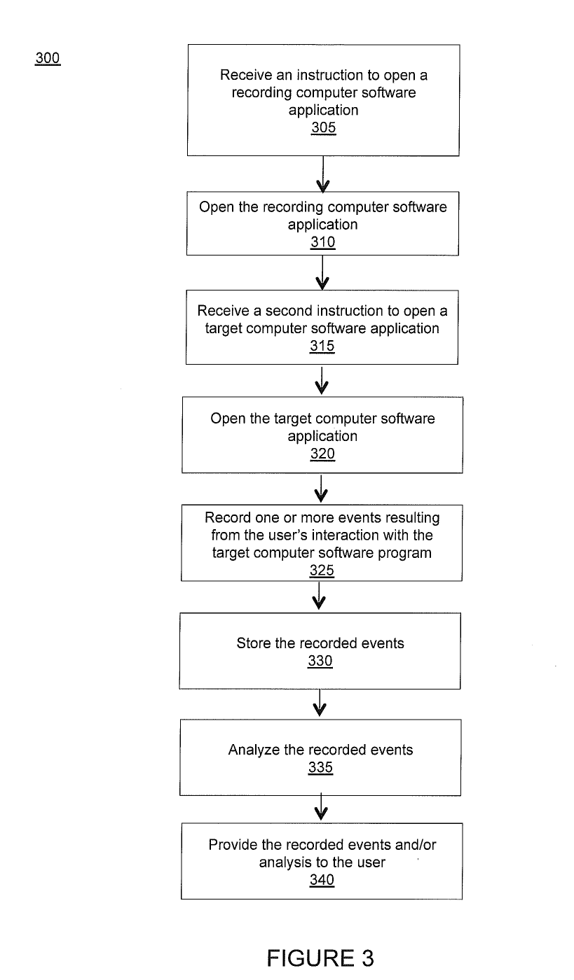

FIG. 3 depicts a flowchart illustrating an exemplary process 300 for performing one or more methods described herein. Process 300 may be executed by any system, or system component, described herein including computer system 110.

In step 305, a first instruction from a user to open a recording computer software application in a recording Web browser session presented by a first Web browser may be received. The recording computer software application may be configured to record the user's interaction with a target computer software application operating during a target Web browser session. In step 310, the recording computer software application may be opened, or otherwise launched, in the recording Web browser session responsively to the received instruction.

A second instruction may then be received from the user to open a target computer software application in a target Web browser session presented by a second Web browser (step 315) and the target computer software application within the target Web browser session responsively to the received request (step 320). At times, the target computer software application may be opened by the recording application running on the computer system.

One or more events resulting from the user's interaction with the target computer software application within the target Web browser session may then be recorded by the recording application (step 325). At times, the one or more events may be triggered by performance of computer software testing operation, such as a test script, by the user as part of a performance test of the target computer software application.

At times, the record of events may be stored in, for example, a database or other data storage device (step 330). Optionally, the recorded events may be analyzed (step 335) and the recorded events and/or results of the analysis may be provided to the user (step 340). On some occasions, performance of the analysis of step 335 may include transmitting recorded events to, for example, a processor running an analysis software application and/or analytics hardware.

In some embodiments, recorded events may be used to automatically execute actions using the target computer software application in order to, for example, perform a test of the target computer software application. On some occasions, the recorded events may be used as a test script for testing the target computer software application.

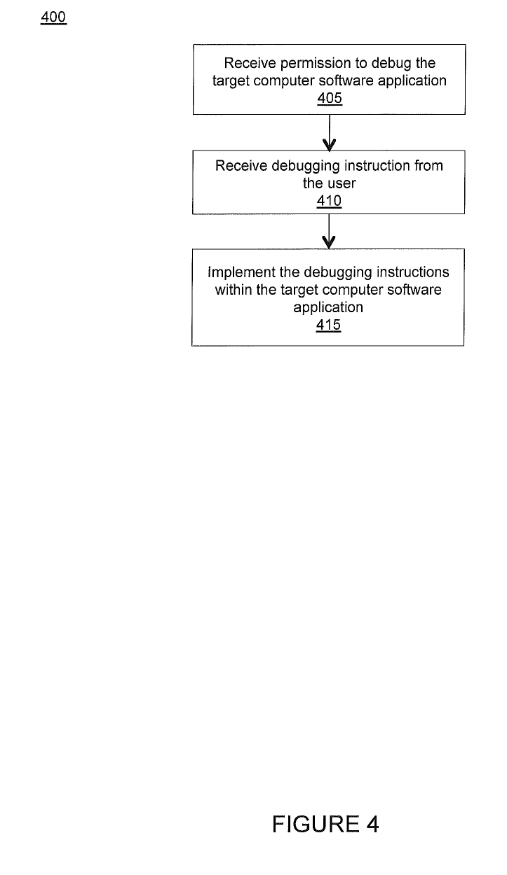

FIG. 4 depicts a flowchart illustrating an exemplary process 400 for debugging the target computer software application. Process 400 may be executed by any system, or system component, described herein including computer system 110.

In step 505, permission to debug the target software application may be received from, for example, the target software application by the computer system. The permission may be received upon, for example, execution of a test script by the user via the target software application. Debugging instructions may then be received from the user (step 410) and implemented within the target computer software application (step 415).

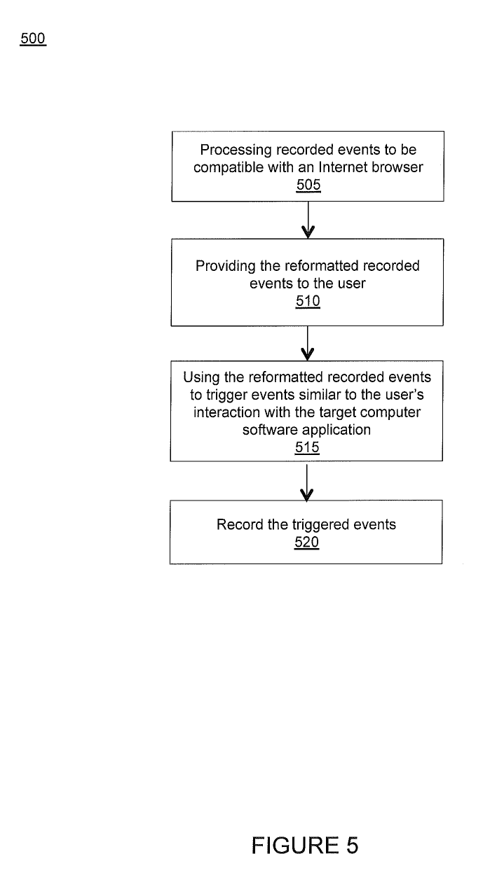

FIG. 5 depicts a flowchart illustrating an exemplary process 500 for performing one or more methods described herein. Process 500 may be executed by any system, or system component, described herein including computer system 110.

In step 505, recorded events may be processed to be compatible with a Web browser other than the second Web browser. Step 505 may be necessary when, for example, events recorded using one Web browser may not be compatible for playback or use with another Web browser. Step 505 may include, for example, processing recorded events to recognize objects and/or normalize the recorded events for use with an application programming interfaces (API) native to a Web browser other than the second Web browser. In some embodiments, the processing may be user configurable. Step 505 may also include reformatting recorded events into a test script for testing the target computer software application.

For example, execution of step 505 may include recognizing Rich Internet Applications (e.g., RIA, using Ajax) and Flex/Flash components using the Web browser native APIs.

In some instances, the processed and/or reformatted recorded events and/or test script may be provided to the user (step 510). The reformatted recorded events may be used to trigger events similar to the user's interaction with the target computer software application (step 515) and the triggered events may be recorded (step 520). In some embodiments, the recorded triggered events may be analyzed to determine, for example, the performance of the target computer software application.

In some embodiments, the recorded triggered events may be played back via any browser that provides a JavaScript environment, DOM APIs, and W3C Web Driver APIs, including, for example, Apple Safari, Microsoft Internet Explorer, Google Chrome, Mozilla Firefox, Weskit browsers, and Opera.

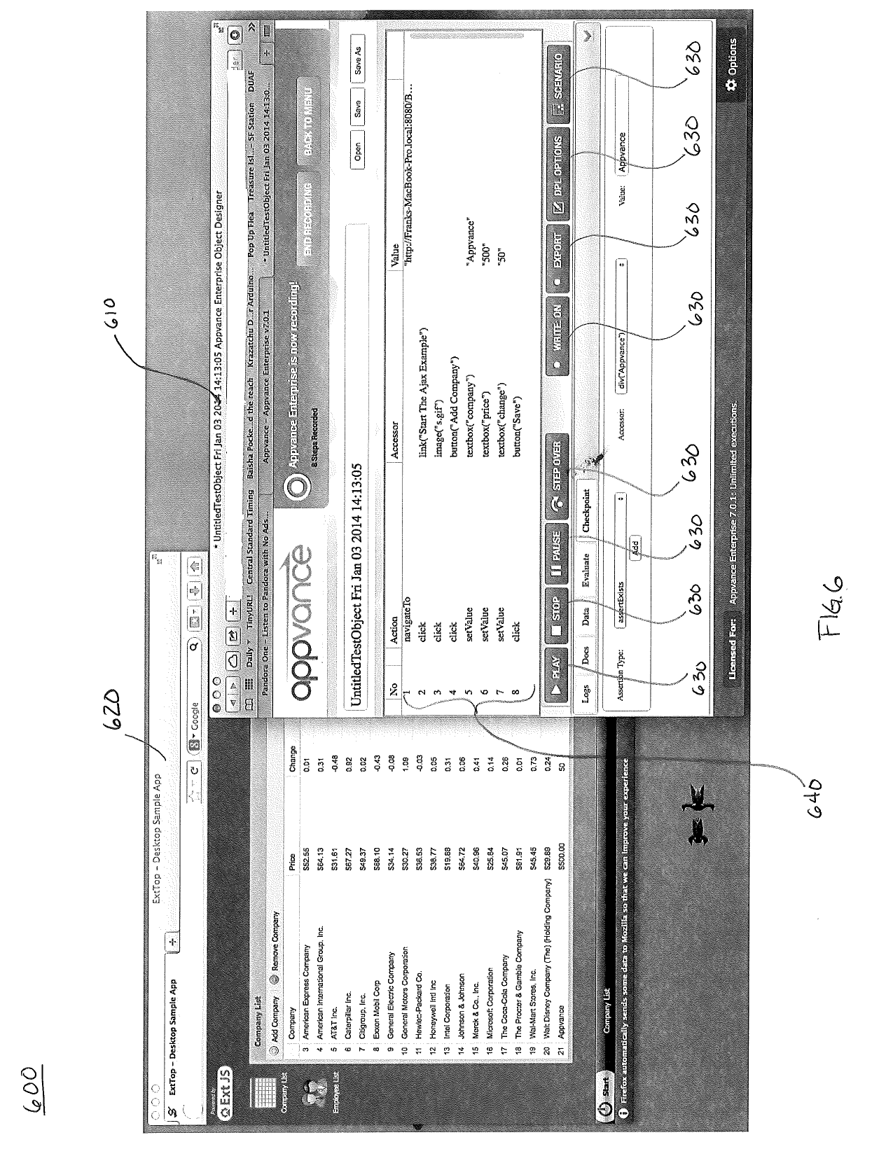

FIG. 6 is an exemplary screen shot of an interface 600 illustrating a window 610 for a recording computer software application interface and a window 620 for a target computer software application interface. On some occasions, the Web browser presenting window 610 may be different from the Web browser presenting window 620.

The interface of window 610 includes user selectable buttons 630 to enable a user to play, stop, pause, step over, write on, and export recorded events. The interface of window 610 also includes a list of recorded events 640 and a notice that the recording computer software application is recording events occurring within the target computer software application.

The interface of window 620 includes a company list presented by the target computer software program. A user's interaction with the interface of window 620 of the target computer software program is recorded by the recording computer software program provided in window 610.

Hence, methods, systems, and non-transitory machine-readable medium for performing an automated testing of a computer software application have been herein described.

What is claimed is:

1. A method comprising:
receiving, by a computer system communicatively coupled to the World Wide Web (Web), a first instruction from a user to open a recording computer software application in a recording Web browser session presented by a first Web browser, the recording computer software application being configured to record the user's interaction with a target computer software application operating during a target Web browser session;
opening, by the computer system, the recording computer software application in the recording Web browser session responsively to the received first instruction;
receiving, by the computer system, a second instruction from the user to open a target computer software application in a target Web browser session presented by a second Web browser;
opening, by the recording application running on the computer system, the target computer software application within the target Web browser session responsively to the received second instruction; and
recording, by the recording application running on the computer system, one or more events resulting from the user's interaction with the target computer software application running within the target Web browser session.

2. The method of claim 1, wherein the one or more events are triggered by operation of a test script by the user as part of a performance test of the target computer software application.

3. The method of claim 1, further comprising:
providing, by the computer system, recorded events to the user via the recording Web browser session.

4. The method of claim 1, further comprising:
analyzing, by the computer system, recorded events; and
communicating, by the computer system, the analysis to the user.

5. The method of claim 1, further comprising:
transmitting, by the computer system, recorded events to at least one of a processor running a software analysis computer software application and analytics hardware.

6. The method of claim 1, further comprising:
receiving, upon execution of a test script by the user via the target software application, permission to debug the target software application from the target software application by the computer system;
receiving, by the computer system, debugging instructions from the user; and
implementing, by the computer system, the debugging instructions within the target computer software application.

7. The method of claim 1, further comprising:
storing, by the computer system, recorded events in a database as at least one of a formatted file and source code.

8. The method of claim 1, further comprising:
using, by the computer system, recorded events to automatically execute actions within the target computer software program.

9. The method of claim 1, further comprising:
reformatting, by the computer system, recorded events to be compatible with a Web browser other than the second Web browser; and
providing, by the computer system, the reformatted recorded events to the user via the first Web browser.

10. The method of claim 9, further comprising:
using, by the computer system, the reformatted recorded events to trigger events similar to the user's interaction with the target computer software application while a Web browser other than the second Web browser presents the target computer software application; and
recording, by the recording application running on the computer system, one or more events triggered by using the reformatted recorded events.

11. The method of claim 1, further comprising:
processing, by the computer system, recorded events to recognize objects;
reformatting the objects to be compatible with a Web browser other than the second Web browser; and
providing, by the computer system, the reformatted objects to the user via the first Web browser.

12. The method of claim 11, further comprising:
using, by the computer system, the reformatted recorded objects to trigger events similar to the user's interaction with the target computer software application while a Web browser other than the second Web browser presents the target computer software application; and
recording, by the recording application running on the computer system, one or more events triggered by using the reformatted recorded objects.

13. The method of claim 1, further comprising:
normalizing, by the computer system, the recorded events for use with an application programming interface (API) native to a Web browser other than the second Web browser; and
using, by the computer system, the normalized recording to perform a test of the target computer software application while the Web browser other than the second Web browser presents the target computer software application; and
recording, by the recording application running on the computer system, the performance of the test.

14. The method of claim 1, further comprising:
normalizing, by the computer system, the recoding for use with an application programming interface (API) native to a Web browser other than the second Web browser, the normalization being user configurable;
using, by the computer system, the normalized recording to perform a test of the target computer software application while the Web browser other than the second Web browser presents the target computer software application; and
recording, by the recording application running on the computer system, the performance of the test.

15. A system comprising:
a computer system communicatively coupled to the World Wide Web via a communication port, the computer system being configured to receive a first instruction from a user to open a recording computer software application in a recording Web browser session presented by a first Web browser, the recording computer software application being configured to record the user's interaction with a target computer software application operating during a target Web browser session, open the recording computer software application in the recording Web browser session responsively to the received first instruction, receive a second instruction from the user to open a target computer software application in a target Web browser session presented by a second Web browser, open the target computer software application within the target Web browser session responsively to the received second instruction, and record one or more events resulting from the user's interaction with the target computer software application running within the target Web browser session;
the communication port communicatively coupled to the computer system and the Web, the communication port being configured to facilitate communication between the computer system and the Web.

16. The system of claim 15, further comprising:
a database communicatively coupled to the computer system via the communication port, the database being configured to store recorded events.

17. The system of claim 15, further comprising:
an analyzer communicatively coupled to the computer system via the communication port, the analyzer being configured to analyze recorded events and communicate them to the computer system.

18. A tangible computer readable media configured to store a set of instructions, which when executed by a computer system cause the computer system to:
receive a first instruction from a user to open a recording computer software application in a recording Web browser session presented by a first Web browser, the recording computer software application being configured to record the user's interaction with a target computer software application operating during a target Web browser session;
open the recording computer software application in the recording Web browser session responsively to the received first instruction;
receive a second instruction from the user to open a target computer software application in a target Web browser session presented by a second Web browser;
open the target computer software application within the target Web browser session responsively to the received second instruction; and
record one or more events resulting from the user's interaction with the target computer software application running within the target Web browser session.
